(19) United States
(12) Patent Application Publication
(10) Pub. No.: US 2025/0229983 A1
(43) Pub. Date: Jul. 17, 2025

(54) STORAGE MAGAZINE SYSTEM AND METHOD OF STORING WALL STRUCTURES FOR A MODULAR CONSTRUCTION UNIT

(71) Applicant: Buildz, LLC, Forest City, NC (US)

(72) Inventors: Mark Joseph BELLISSIMO, Wellington, FL (US); Jason Daryl Hunsinger, Forest City, NC (US); Stanley Clark Beard, JR., Hendersonville, NC (US); Harrison Grant Meadows, Hendersonville, NC (US); Benjamin Austin Tucker, Boiling Springs, SC (US)

(21) Appl. No.: 19/022,622

(22) Filed: Jan. 15, 2025

Related U.S. Application Data
(60) Provisional application No. 63/621,327, filed on Jan. 16, 2024.

(51) Int. Cl. B65G 1/04; B65G 61/00

(52) U.S. Cl. CPC B65G 1/04; B65G 61/00; B65G 2201/022; B65G 2201/0223

(57) ABSTRACT

A storage magazine system and method of storing wall structures of a modular construction unit. The storage magazine system includes a storage magazine. The storage magazine includes a plurality of vertically-oriented frames that extend generally vertically and a plurality of vertically-oriented slots defined between two of the plurality of vertically-oriented frames. The storage magazine also includes a plurality of horizontally-oriented frames that extend generally horizontally, and are disposed within the plurality of vertically-oriented slots. The storage magazine includes a plurality of horizontally-oriented slots, each of the plurality of horizontally-oriented slots is defined by two of the plurality of horizontally-oriented frames and extend horizontally within the plurality of vertically-oriented slots. The plurality of horizontally-oriented slots receive the wall structures therein and secure the wall structures in an upright position.

### CROSS REFERENCE TO RELATED APPLICATIONS

This application claims the benefit of U.S. Provisional Patent Application No. 63/621,327, filed on Jan. 16, 2024, the entire contents of which is hereby incorporated by reference in its entirety.

### TECHNICAL FIELD

The present disclosure relates generally to construction of modular construction units. In particular, the present disclosure relates to a storage magazine system and a method of storing wall structures for a modular construction unit.

### BACKGROUND

The production of modular, or prefabricated, buildings is a growing industry. In this type of manufacturing, sections of a building or structure, also referred to as a modular construction unit, are partially assembled at a remote location, and the sections are then delivered to the final building site, where final construction of the structure is ultimately completed by assembling the various sections together. Such modular construction units can be used for a variety of purposes, including, for example, as temporary or permanent buildings, such as residential homes, commercial offices, educational or service facilities, etc. Wall structures of the modular construction unit may need to be stored after the wall structures have been assembled.

### SUMMARY

A storage magazine system for storing wall structures of a modular construction unit. The storage magazine system has a first longitudinal end and a second longitudinal end opposite the first longitudinal end, and the storage magazine system includes a storage magazine including a plurality of vertically-oriented frames that extend generally vertically, a plurality of vertically-oriented slots, each of the plurality of vertically-oriented slots being defined between two of the plurality of vertically-oriented frames such that the plurality of vertically-oriented slots extend vertically, a plurality of horizontally-oriented frames that extend generally horizontally from the first longitudinal end towards the second longitudinal end, the plurality of horizontally-oriented frames being disposed within the plurality of vertically-oriented slots, and a plurality of horizontally-oriented slots, each of the plurality of horizontally-oriented slots being defined by two of the plurality of horizontally-oriented frames and extending horizontally within the plurality of vertically-oriented slots, wherein the plurality of horizontally-oriented slots receive the wall structures therein and secure the wall structures in an upright position.

A method of storing the wall structures of the modular construction unit in the storage magazine system. The method includes placing the wall structures into the storage magazine, inserting the wall structures into the plurality of horizontally-oriented slots, and securing the wall structures in the upright position within the plurality of horizontally-oriented slots.

### BRIEF DESCRIPTION OF THE DRAWINGS

The foregoing and other features and advantages will be apparent from the following, more particular, description of various exemplary embodiments, as illustrated in the accompanying drawings, wherein like reference numbers generally indicate identical, functionally similar, and/or structurally similar elements.

FIG. 1A is a perspective view of a storage magazine system for storing wall structures for a modular construction unit, according to the present disclosure.

FIG. 1B is a top plan view of the storage magazine system of FIG. 1A, according to the present disclosure.

FIG. 1C is a front plan view of the storage magazine system of FIG. 1A, according to the present disclosure.

FIG. 1D is a side plan view of the storage magazine system of FIG. 1A, according to the present disclosure.

FIG. 2 is a flow diagram of a method of storing wall structures for a modular construction unit, according to the present disclosure.

FIG. 3 illustrates a computing device for controlling aspects of the storage magazine system, according to the present disclosure.

### DETAILED DESCRIPTION

Various embodiments are discussed in detail below. While specific embodiments are discussed, this is done for illustration purposes only. A person skilled in the relevant art will recognize that other components and configurations may be used without departing from the spirit and scope of the present disclosure.

As used herein, the terms “first,” and “second,” etc., may be used interchangeably to distinguish one component from another and are not intended to signify location or importance of the individual components.

The terms “coupled,” “fixed,” “attached,” “connected,” and the like, refer to both direct coupling, fixing, attaching, or connecting as well as indirect coupling, fixing, attaching, or connecting through one or more intermediate components or features, unless otherwise specified herein.

The singular forms “a,” “an,” and “the” include plural references unless the context clearly dictates otherwise.

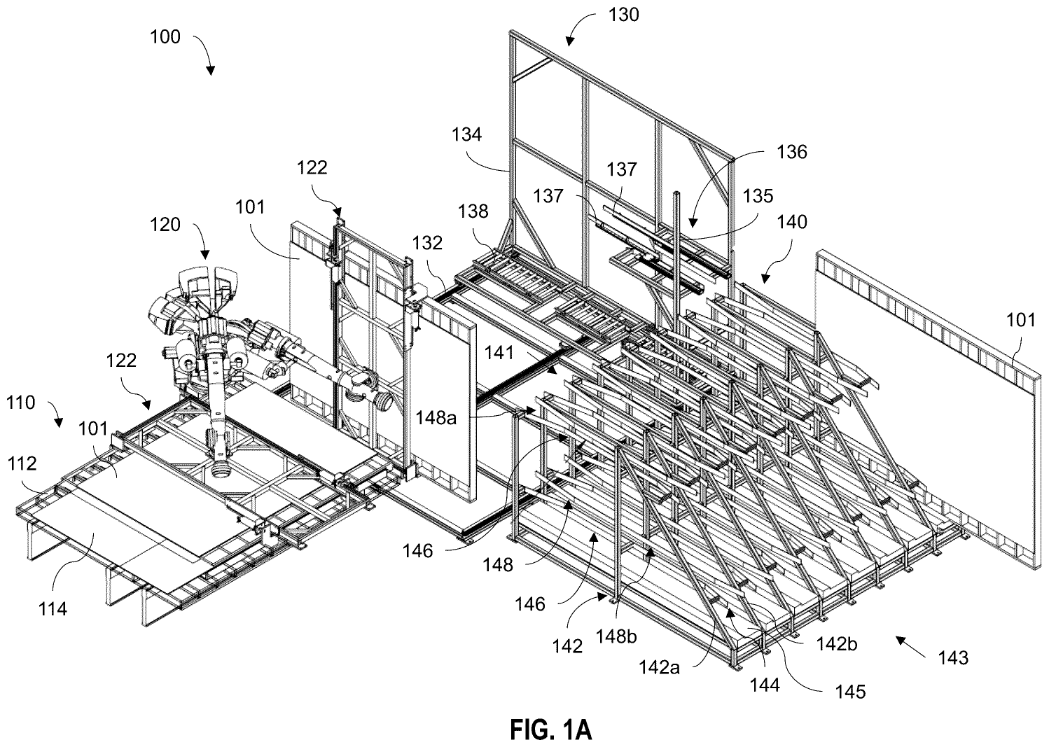

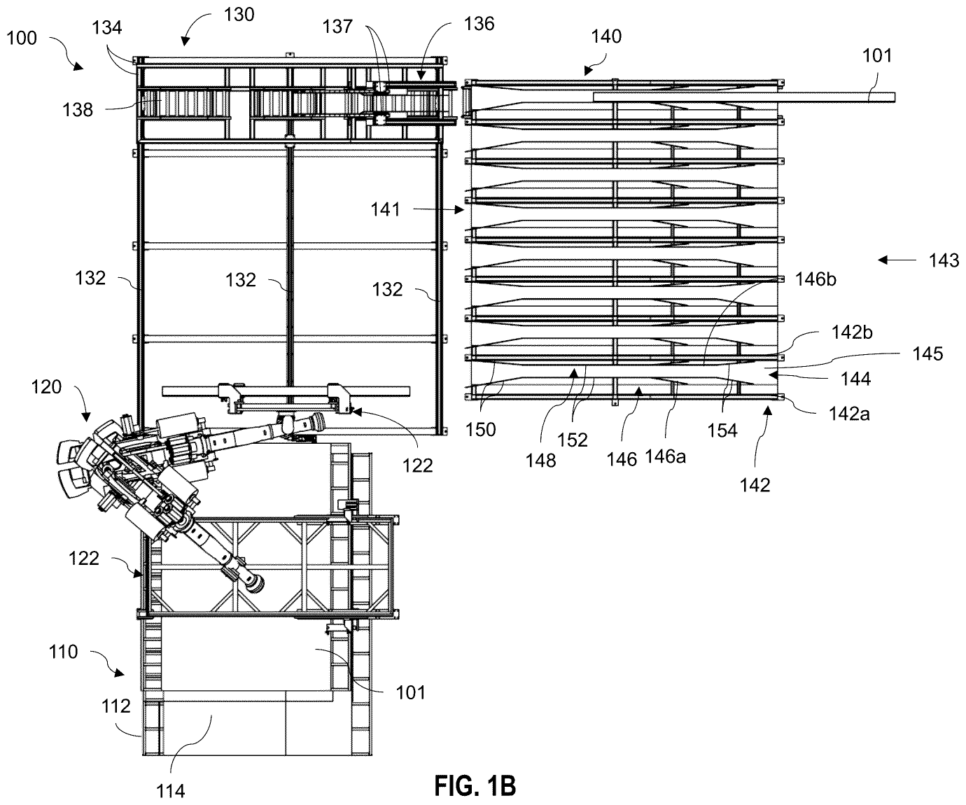

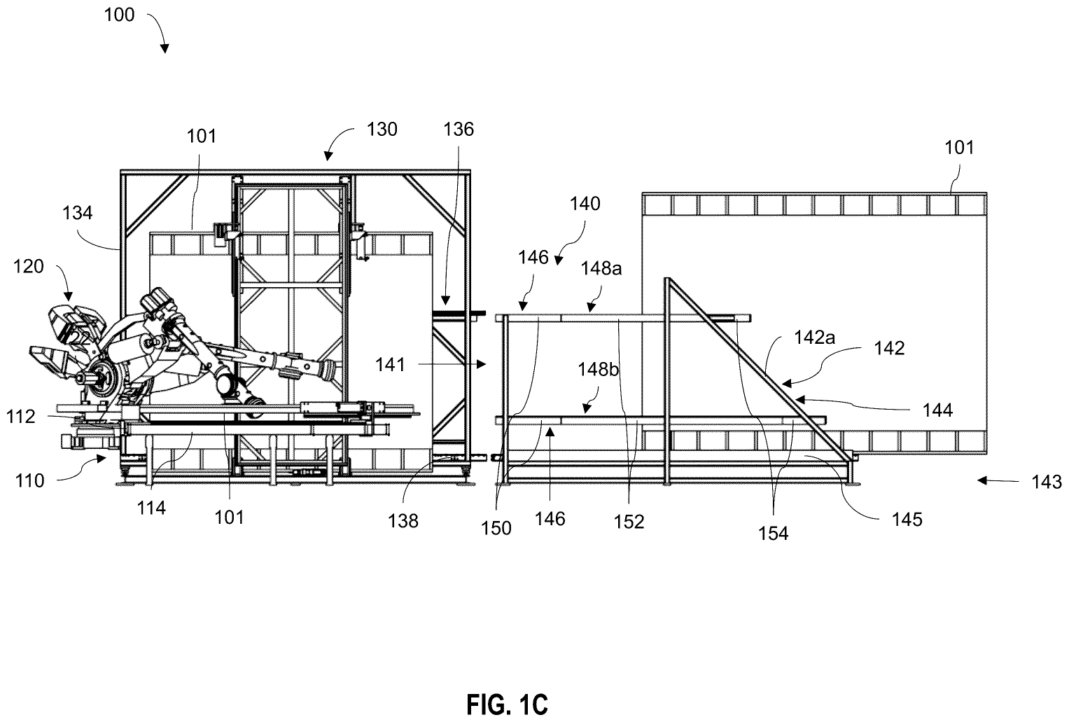

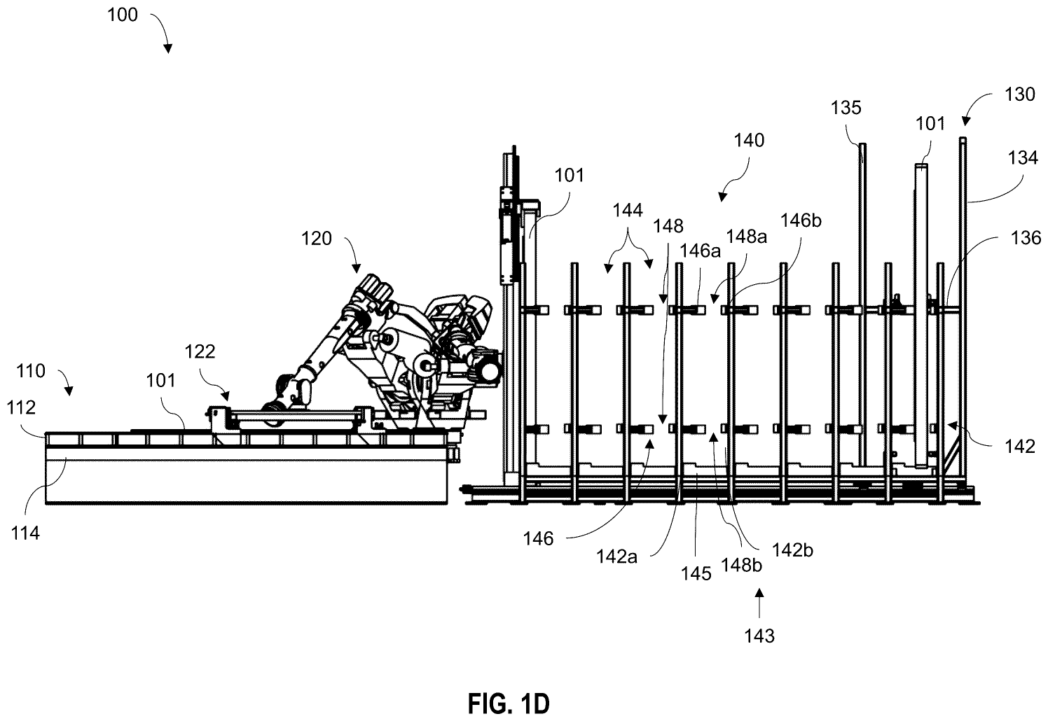

As used herein, a “vertical” or a “vertically-oriented” component is a component that has a long edge that extends in a vertical plane in the orientation of the storage magazine system in FIG. 1A-1C.

As used herein, a “horizontal” or a “horizontally-oriented” component is a component that has a long edge that extends in a horizontal plane in the orientation of the storage magazine system in FIGS. 1A-1C.

As used herein, “adjacent” means two components that are spaced from, or contacting, each other with no intervening components therebetween.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially” is not to be limited to the precise value specified. In at least some instances, the approximating language may correspond to the precision of an instrument for measuring the value, or the precision of the methods or the machines for constructing the components or the systems or manufacturing the components or the systems. For example, the approximating language may refer to being within a one, a two, a four, a ten, a fifteen, or a twenty percent margin in either individual values, range(s) of values or endpoints defining range(s) of values.

As mentioned above, the wall structures of the modular construction unit need to be stored after the wall structures are assembled and prior to the wall structures being transported to a location for assembling the modular construction unit. Current storage systems for storing such wall structures may not fully secure the wall structures in an upright position while being stored. Further, current storage systems may not allow for the wall structures to be easily grabbed and/or lifted from the storage system.

Accordingly, the present disclosure provides for an improved storage magazine system and method of storing wall structures for a modular construction unit. The storage magazine system of the present disclosure includes a storage magazine and a magazine trolley. The storage magazine includes a plurality of horizontally-oriented slots positioned within a plurality of vertically-oriented slots for receiving and securing the wall structures therein. The horizontally-oriented slots include a width that corresponds to the width of the wall structure such that the horizontally-oriented slots hold the wall structures therein in an upright position. The magazine trolley also includes a magazine trolley slot that is horizontally oriented to hold the wall structures therein in the upright position. The magazine trolley transfers the wall structures to the storage magazine and the wall structures are guided into the horizontally-oriented slots to be stored therein. The storage magazine also includes a storage magazine conveyor that transports the wall structures towards an end of the storage magazine such that the wall structures can be easily lifted from the storage magazine and transported to a location for assembling the modular construction unit. The horizontally-oriented slots continue to secure the wall structures as the wall structures move to the end of the storage magazine. Thus, the storage magazine system provides for an improved storage system for storing wall structures therein in an upright position and for easily lifting the wall structures from the storage magazine.

FIGS. 1A to 1D are respective perspective, top plan, front plan, and side plan views of a storage magazine system 100 for storing one or more wall structures 101 for a modular construction unit, according to the present disclosure. The wall structures 101 can be constructed in a system for creating the wall structures 101 for use in creating a modular construction unit. The modular construction unit is, for example, a modular room that is built in a factory, transported in a substantially assembled state to a construction site, and secure to form a larger building, such as, for example, a hotel constructed from a plurality of such modular construction units. By way of example, the system for creating the wall structures 101 may be the system described in U.S. Patent Application Publication No. US2021/0187783, the contents of which are hereby incorporated by reference in their entirety. The storage magazine system 100 can be positioned at an end of the system for creating wall structures 101 such that the completed wall structures 101 are transferred to the storage magazine system 100, where the wall structures 101 are moved, via an automated robot, from a horizontal transport position into a vertical storage position for storing the wall structures 101 in a storage magazine, as detailed further below.

The storage magazine system 100 includes a wall frame transport 110, a storage robot 120, a magazine trolley 130, and a storage magazine 140. The wall frame transport 110 includes a wall frame conveyor 112 that comprises one or more tracks 114, which can include segmented conveyors, belts, chains, or any other suitable device for supporting and moving a wall structure 101 thereon. The storage robot 120 can be any suitable type of automated robot device, system, apparatus, etc. In particular, the storage robot 120 is a 6-axis robotic arm having a lifter frame 122 attached at a distal end of the storage robot 120 (e.g., a distal end of the robotic arm). The storage robot 120 is shown schematically in two positions in FIGS. 1A to 1C for illustrative purposes, engaging with the wall structure 101 on the wall frame conveyor 112 and placing the wall structure 101 to align with the magazine trolley 130. The storage robot 120 engages with the wall structure 101 on the wall frame conveyor 112. In particular, the lifter frame 122 is configured to engage and/or clamp around edges of the wall structure 101 for transporting the wall structure 101 from the wall frame transport 110 on the magazine trolley 130, as detailed further below.

The magazine trolley 130 includes one or more magazine trolley tracks 132, a magazine trolley frame 134, a magazine trolley slot 136, and a magazine trolley conveyor 138. The magazine trolley tracks 132 can comprise, for example, chain-driven conveyors that move the magazine trolley 130 thereon. The magazine trolley frame 134 is movably coupled to the magazine trolley tracks 132 and supports the magazine trolley slot 136 and the magazine trolley conveyor 138 thereon. The magazine trolley slot 136 includes one or more vertical magazine trolley frames 135 that extend vertically from the magazine trolley frame 134, and a plurality of horizontal magazine trolley frames 137 that extend horizontally. The plurality of horizontal magazine trolley frames 137 is coupled to the one or more vertical magazine trolley frames 135. The plurality of horizontal magazine trolley frames 137 includes two horizontal magazine trolley frames 137 that are spaced laterally from each other to define the magazine trolley slot 136. In particular, the magazine trolley slot 136 includes a distance between the horizontal magazine trolley frames 137 to grip the wall structure 101 between the plurality of horizontal magazine trolley frames 137. In this way, the magazine trolley slot 136 is horizontally oriented to hold the wall structure 101 therein in an upright position. The magazine trolley conveyor 138 includes a plurality rollers, which can be any combination of drive rollers and idler rollers, including all drive rollers. In this way, the magazine trolley conveyor 138 is configured to move the wall structure 101 towards the storage magazine 140, as detailed further below.

The storage magazine 140 has a first longitudinal end 141 and a second longitudinal end 143 opposite the first longitudinal end 141. The first longitudinal end 141 is positioned adjacent the magazine trolley 130 such that the wall structures 101 are moved from the magazine trolley 130 into the storage magazine 140 at the first longitudinal end 141, as detailed further below. The second longitudinal end 143 is opposite the first longitudinal end 141 and the wall structures 101 can be lifted out of the storage magazine 140 at the second longitudinal end 143.

The storage magazine 140 includes a plurality of vertically-oriented frames 142, a plurality of vertically-oriented slots 144, a plurality of horizontally-oriented frames 146, and a plurality of horizontally-oriented slots 148. The plurality of vertically-oriented frames 142 extend generally vertically. The plurality of vertically-oriented slots 144 are defined between a first vertically-oriented frame 142a and a second vertically-oriented frame 142b. Each of the plurality of vertically-oriented slots 144 includes a storage magazine conveyor 145 positioned at a bottom of the vertically-oriented slots 144. The storage magazine conveyor 145 includes a plurality rollers, which can be any combination of drive rollers and idler rollers, including all drive rollers. In this way, the storage magazine conveyor 145 is configured to move the wall structure 101 towards an end of the storage magazine 140 away from the magazine trolley 130, as detailed further below.

The plurality of horizontally-oriented frames 146 extend generally horizontally within a respective vertically-oriented slot 144, for example, between the first vertically-oriented frame 142a and the second vertically-oriented frame 142b. The plurality of horizontally-oriented slots 148 are defined by the plurality of horizontally-oriented frames 146. In FIGS. 1A-1D, the plurality of horizontally-oriented slots 148 include a first horizontally-oriented slot 148a and a second horizontally-oriented slot 148b within each of the vertically-oriented slots 144. In particular, the first horizontally-oriented slot 148a is positioned generally at a top portion of the vertically-oriented slots 144 and the second horizontally-oriented slot 148b is positioned at a bottom portion of the vertically-oriented slots 144.

As shown in FIG. 1B, each of the plurality of horizontally-oriented slots 148 is defined between a first horizontally-oriented frame 146a and a second horizontally-oriented frame 146b. The first horizontally-oriented frame 146a is coupled to the first vertically-oriented frame 142a, and the second horizontally-oriented frame 146b is coupled to the second vertically-oriented frame 142b. In this way, the second horizontally-oriented frame 146b is spaced laterally from the first horizontally-oriented frame 146a, and the horizontally-oriented slot 148 is defined between the first horizontally-oriented frame 146a and the second horizontally-oriented frame 146b.

Each of the plurality of horizontally-oriented frames 146 includes an inwardly tapered section 150, a straight section 152, and an outwardly tapered section 154. The inwardly tapered section 150, the straight section 152, and the outwardly tapered section 154 can include a single, unitary component to form each of the horizontally-oriented frames 146, or two or more of the inwardly tapered section 150, the straight section 152, or the outwardly tapered section 154 can be formed of separate components.

The inwardly tapered section 150 is positioned at the first longitudinal end 141 of the storage magazine 140 and extends longitudinally toward the second longitudinal end 143. The inwardly tapered section 150 angles inward from an outer portion of the vertically-oriented slot 144 towards a center of the vertically-oriented slot 144. For example, the inwardly tapered section 150 of the first horizontally-oriented frame 146a extends from the first vertically-oriented frame 142a towards the second vertically-oriented frame 142b. Likewise, the inwardly tapered section 150 of the second horizontally-oriented frame 146b extends from the second vertically-oriented frame 142b towards the first vertically-oriented frame 142a. In this way, a width of the horizontally-oriented slot 148 decreases from the first longitudinal end 141 to the straight section 152 by the inwardly tapered section 150.

The straight section 152 extends longitudinally, or horizontally, from the inwardly tapered section 150 towards the second longitudinal end 143. The straight section 152 is parallel with a longitudinal centerline of the vertically-oriented slot 144 such that the straight section 152 is not angled towards or away from the center of the vertically-oriented slot 144. In this way, the width of the horizontally-oriented slot 148 remains substantially constant along a length of the straight section 152. The straight section 152 of the first horizontally-oriented frame 146a and the straight section 152 of the second horizontally-oriented frame 146b define the horizontally-oriented slot 148 therebetween. The width of the horizontally-oriented slot 148 at the straight section 152 corresponds to a width of the wall structure 101 such that the wall structure 101 is secured within the horizontally-oriented slot 148 between the straight section 152 of the first horizontally-oriented frame 146a and the straight section 152 of the second horizontally-oriented frame 146b. In this way, the horizontally-oriented slot 148 supports the wall structure 101 such that the wall structure 101 is disposed upright when stored in the storage magazine 140.

The outwardly tapered section 154 extends longitudinally from the straight section 152 towards the second longitudinal end 143 of the storage magazine 140. The outwardly tapered section 154 angles outward from the straight section 152 towards the outer portion of the vertically-oriented slot 144, and away from the center of the vertically-oriented slot 144. For example, the outwardly tapered section 154 of the first horizontally-oriented frame 146a extends from the straight section 152 of the first horizontally-oriented frame 146a towards the first vertically-oriented frame 142a. Likewise, the outwardly tapered section 154 of the second horizontally-oriented frame 146b extends from the straight section 152 of the second horizontally-oriented frame 146b towards the second vertically-oriented frame 142b. In this way, a width of the horizontally-oriented slot 148 increase from the straight section 152 to the second longitudinal end 143 by the outwardly tapered section 154.

In operation, the wall frame transport 110 transports the wall structure 101 to a position adjacent the storage robot 120. In particular, the tracks 114 of the wall frame conveyor 112 transport the wall structure 101 towards the storage robot 120. In some embodiments, the wall structure 101 is placed on the wall frame transport 110 after the wall structure 101 is assembled by the system of U.S. Patent Application Publication No. US2021/0187783). The storage robot 120 engages the wall structure 101 on the wall frame transport 110. In particular, the lifter frame 122 engages or clamps around the edges of the wall structure 101, and the storage robot 120 transports the wall structure 101 from the wall frame transport 110 to the magazine trolley 130. The magazine trolley 130 moves along the magazine trolley tracks 132 to a position adjacent the storage robot 120. The storage robot 120 thus places the wall structure 101 onto the magazine trolley 130. In particular, the storage robot 120 places the wall structure 101 onto the magazine trolley conveyor 138 and inserts the wall structure 101 into the magazine trolley slot 136. In this way, the magazine trolley 130 supports the wall structure 101 upright within the magazine trolley slot 136. For example, the horizontal magazine trolley frames 137 support the wall structure 101 between the horizontal magazine trolley frames 137.

Once the wall structure 101 is transferred onto the magazine trolley 130 by the storage robot 120, the lifter frame 122 disengages from the wall structure 101 and the storage robot 120 returns to a position over the wall frame transport 110. The magazine trolley 130 moves along the magazine trolley tracks 132 to align the wall structure 101 on the magazine trolley 130 with one of the vertically-oriented slots 144. In particular, the magazine trolley tracks 132 move the magazine trolley 130 thereon to move the wall structure 101 to align with one of the vertically-oriented slots 144. For example, the magazine trolley 130 can align the wall structure 101 with any one of the vertically-oriented slots 144, and in particular, aligns the wall structure 101 with an empty one of the vertically-oriented slots 144. An empty one of the vertically-oriented slots 144 is a vertically-oriented slot 144 without a wall structure 101 therein.

Once the wall structure 101 is aligned with a designated one of the vertically-oriented slots 144, the magazine trolley conveyor 138 (e.g., the drive rollers) is activated to transport the wall structure 101 from the magazine trolley 130 into the designated one of the vertically-oriented slots 144. As the wall structure 101 is transferred into the designated one of the vertically-oriented slots 144 of the storage magazine 140, wall structure 101 passes into the horizontally-oriented slot 148 of the designated one of the vertically-oriented slots 144. In particular, the inwardly tapered section 150 guides the wall structure 101 towards the straight section 152. The straight section 152 supports the wall structure 101 therein. In some embodiments, the storage magazine conveyor 145 moves the wall structure 101 from the first longitudinal end 141 towards the second longitudinal end 143 once the wall structure 101 is transported onto the storage magazine 140 from the magazine trolley conveyor 138. Thus, the storage magazine 140 stores the wall structure 101 therein and the horizontally-oriented frames 146 (e.g., the straight section 152) support the wall structure 101 such that the wall structure 101 stands upright within the storage magazine 140.

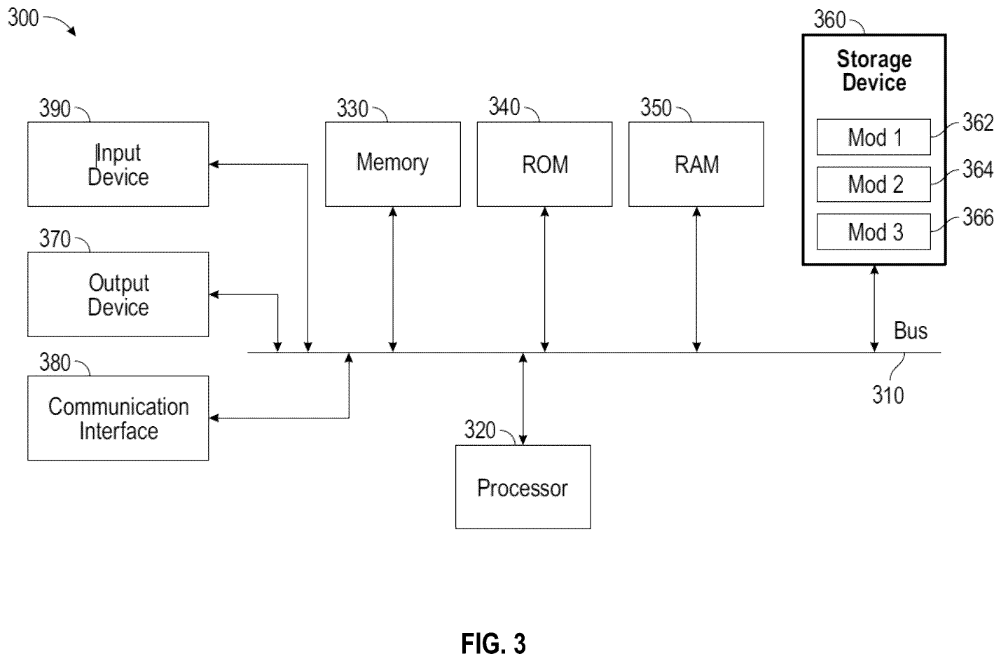

Once the wall structure 101 is fully transferred from the magazine trolley 130 into a designated one of the vertically-oriented slots 144, the magazine trolley 130 moves to a position adjacent the storage robot 120 where a next wall structure 101 will be transferred from the wall frame transport 110 onto the magazine trolley 130 by the storage robot 120 and the process of aligning the magazine trolley 130 with a designated one of the vertically-oriented slots 144 and transferring the wall structure 101 into the designated one of the vertically-oriented slots 144 is repeated. The position (e.g., the particular vertically-oriented slot 144) in which each of the wall structures 101 are loaded into the storage magazine 140 is tracked by a controller (e.g., the processor 320 of the computing device 300 of FIG. 3), for example, in a memory 330. Based on which modular construction units are being assembled, the controller indicates in which vertically-oriented slot 144 a needed wall structure 101 is located, such that the needed wall structure 101 can be removed from the vertically-oriented slot 144 (e.g., by an overhead crane). When the wall structure 101 is removed from the storage magazine 140, the storage magazine conveyor 145 can move the wall structure 101 towards the second longitudinal end 143 and the wall structure 101 is released from the storage magazine 140 by the outwardly tapered section 154 such that the wall structure 101 can easily be removed. The wall structure 101 can then be transported to a final assembly area where the wall structure 101 is assembled with other components of the modular construction unit.

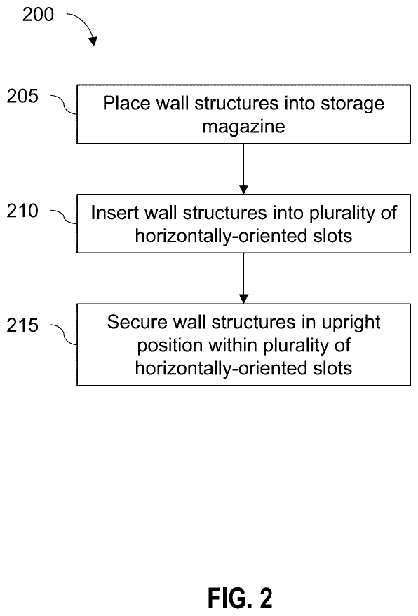

FIG. 2 is a flow diagram of a method 200 of storing wall structures 101 for a modular construction unit, according to the present disclosure. Steps of the method 200 can proceed automatically, for example, by a processor (e.g., of the computing device 300 of FIG. 3) controlling the storage magazine system 100.

In step 205, the method 200 includes placing the wall structures 101 into the storage magazine 140. In step 210, the method 200 includes inserting the wall structures 101 into the plurality of horizontally-oriented slots 148. In step 215, the method 200 includes securing the wall structures 101 in the upright position within the plurality of horizontally-oriented slots 148. The method 200 includes any of the operations detailed herein with respect to FIGS. 1A to 1D, including in any order of the operations, or any combinations thereof.

FIG. 3 illustrates a computing device 300 for controlling aspects of the storage magazine system 100, according to the present disclosure. The computing device 300 can carry out instructions for controlling the components of the storage magazine system 100, such as, for example, the wall frame transport 110, the storage robot 120, the magazine trolley 130, and the storage magazine 140. While a single computing device 300 is illustrated in FIG. 3, the storage magazine system 100 can include any number of computing devices 300 for controlling the components thereof, and performing the method 200 of storing wall structures for the modular construction unit.

The computing device 300 includes a processing unit (CPU or processor) 320 and a system bus 310 that couples various system components including a memory 330 such as read-only memory (ROM) 340 and random-access memory (RAM) 350 to the processor 320. The computing device 300 can include a cache of high-speed memory connected directly with, in close proximity to, or integrated as part of the processor 320. The computing device 300 copies data from the memory 330 and/or the storage device 360 to the cache for quick access by the processor 320. In this way, the cache provides a performance boost that avoids processor 320 delays while waiting for data. These and other modules can control or be configured to control the processor 320 to perform various actions. Other memory 330 may be available for use as well. The memory 330 can include multiple different types of memory with different performance characteristics. It can be appreciated that the disclosure may operate on a computing device 300 with more than one processor 320 or on a group or cluster of computing devices networked together to provide greater processing capability. The processor 320 can include any general-purpose processor and a hardware module or software module, such as module 1 362, module 2 364, and module 3 366 stored in storage device 360, configured to control the processor 320 as well as a special-purpose processor where software instructions are incorporated into the actual processor design. The processor 320 may essentially be a completely self-contained computing system, containing multiple cores or processors, a bus, memory controller, cache, etc. A multi-core processor may be symmetric or asymmetric.

The system bus 310 may be any of several types of bus structures including a memory bus or memory controller, a peripheral bus, and a local bus using any of a variety of bus architectures. A basic input/output (BIOS) stored in ROM 340 or the like, may provide the basic routine that helps to transfer information between elements within the computing device 300, such as during start-up. The computing device 300 further includes storage devices 360 such as a hard disk drive, a magnetic disk drive, an optical disk drive, tape drive or the like. The storage device 360 can include software modules 362, 364, 366 for controlling the processor 320. Other hardware or software modules are contemplated. The storage device 360 is connected to the system bus 310 by a drive interface. The drives and the associated computer-readable storage media provide nonvolatile storage of computer-readable instructions, data structures, program modules and other data for the computing device 300. In one aspect, a hardware module that performs a particular function includes the software component stored in a tangible computer-readable storage medium in connection with the necessary hardware components, such as the processor 320, system bus 310, output device 370, and so forth, to carry out the function. In another aspect, the system can use a processor and computer-readable storage medium to store instructions which, when executed by a processor (e.g., one or more processors), cause the processor to perform a method or other specific actions. The basic components and appropriate variations are contemplated depending on the type of device, such as whether the computing device 300 is a small, handheld computing device, a desktop computer, or a computer server.

Although the exemplary embodiment described herein employs the storage device 360, other types of computer-readable media which can store data that are accessible by a computer, such as magnetic cassettes, flash memory cards, digital versatile disks, cartridges, random-access memories (RAMs) 350, and read-only memory (ROM) 340, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 300, an input device 390 represents any number of input mechanisms, such as a microphone for speech, a touch-sensitive screen for gesture or graphical input, keyboard, mouse, motion input, speech and so forth. An output device 370 can also be one or more of a number of output mechanisms known to those of skill in the art, such as, for example, a display. In some instances, multimodal systems enable a user to provide multiple types of input to communicate with the computing device 300. The communications interface 380 generally governs and manages the user input and system output. There is no restriction on operating on any particular hardware arrangement and therefore the basic features here may easily be substituted for improved hardware or firmware arrangements as they are developed.

Further aspects of the present disclosure are provided by the subject matter of the following clauses.

A storage magazine system for storing wall structures of a modular construction unit, the storage magazine system having a first longitudinal end and a second longitudinal end opposite the first longitudinal end, and the storage magazine system comprising a storage magazine comprising a plurality of vertically-oriented frames that extend generally vertically, a plurality of vertically-oriented slots, each of the plurality of vertically-oriented slots being defined between two of the plurality of vertically-oriented frames such that the plurality of vertically-oriented slots extend vertically, a plurality of horizontally-oriented frames that extend generally horizontally from the first longitudinal end towards the second longitudinal end, the plurality of horizontally-oriented frames being disposed within the plurality of vertically-oriented slots, and a plurality of horizontally-oriented slots, each of the plurality of horizontally-oriented slots being defined by two of the plurality of horizontally-oriented frames and extending horizontally within the plurality of vertically-oriented slots, wherein the plurality of horizontally-oriented slots receive the wall structures therein and secure the wall structures in an upright position.

The storage magazine system of the preceding clause, wherein each of the plurality of horizontally-oriented frames includes an inwardly tapered section that extends from the first longitudinal end toward the second longitudinal end, and the inwardly tapered section is angled inward towards a center of a respective one of the plurality of vertically-oriented slots.

The storage magazine system of any preceding clause, wherein each of the plurality of horizontally-oriented frames includes a straight section that extends from the inwardly tapered section towards the second longitudinal end, and the straight section extends generally horizontally from the inwardly tapered section.

The storage magazine system of any preceding clause, wherein each of the plurality of horizontally-oriented frames includes an outwardly tapered section that extends from the straight section toward the second longitudinal end, and the outwardly tapered section is angled outward from the straight section away from the center of respective one of the plurality of vertically-oriented slots.

The storage magazine system of any preceding clause, wherein the plurality of horizontally-oriented slots includes a first horizontally-oriented slot and a second horizontally-oriented slot within each of the plurality of vertically-oriented slots.

The storage magazine system of any preceding clause, wherein the first horizontally-oriented slot is positioned generally at a top portion of a respective one of the plurality of vertically-oriented slots.

The storage magazine system of any preceding clause, wherein the second horizontally-oriented slot is positioned generally at a bottom portion of the respective one of the plurality of vertically-oriented slots.

The storage magazine system of any preceding clause, wherein each of the plurality of vertically-oriented slots is defined between a first vertically-oriented frame and a second vertically-oriented frame, each of the plurality of horizontally-oriented slots is defined between a first horizontally-oriented frame and a second horizontally-oriented frame, and the first horizontally-oriented frame is coupled to the first vertically-oriented frame and the second horizontally-oriented frame is coupled to the second vertically-oriented frame.

The storage magazine system of any preceding clause, wherein each of the plurality of vertically-oriented slots includes a storage magazine conveyor that is configured to move the wall structures thereon towards the second longitudinal end.

The storage magazine system of any preceding clause, further comprising a magazine trolley having a magazine trolley slot that extends generally horizontally, wherein the magazine trolley is configured to receive a respective wall structure within the magazine trolley slot and move to align the respective wall structure with a designated one of the plurality of vertically-oriented slots to transfer the respective wall structure into the designated one of the plurality of vertically-oriented slots.

The storage magazine system of any preceding clause, wherein the magazine trolley includes one or more magazine trolley tracks that are configured to move the magazine trolley thereon.

The storage magazine system of any preceding clause, wherein the magazine trolley slot is defined by a plurality of horizontal magazine trolley frames that are spaced laterally from each other.

The storage magazine system of any preceding clause, wherein the magazine trolley includes a magazine trolley conveyor that is configured to move the respective wall structure towards the storage magazine for transferring the respective wall structure into one of the plurality of vertically-oriented slots.

The storage magazine system of any preceding clause, further comprising a wall frame transport and a storage robot, wherein the wall frame transport is configured to move the respective wall structure thereon towards the storage robot, and the storage robot is configured to engage the respective wall structure on the wall frame transport and transport the respective wall structure onto the magazine trolley and within the magazine trolley slot such that the respective wall structure is in the upright position within the magazine trolley slot.

A method of storing the wall structures of the modular construction unit in the storage magazine system of any preceding clause, the method comprising placing the wall structures into the storage magazine, inserting the wall structures into the plurality of horizontally-oriented slots, and securing the wall structures in the upright position within the plurality of horizontally-oriented slots.

The method of any preceding clause, wherein each of the plurality of horizontally-oriented frames includes an inwardly tapered section that extends from the first longitudinal end toward the second longitudinal end, the inwardly tapered section is angled inward towards a center of a respective one of the plurality of vertically-oriented slots, and the method further comprises guiding, by the inwardly tapered section, the wall structures into the plurality of horizontally-oriented slots.

The method of any preceding clause, wherein each of the plurality of horizontally-oriented frames includes a straight section that extends from the inwardly tapered section towards the second longitudinal end, the straight section extends generally horizontally from the inwardly tapered section, and the method further comprises securing, by the straight section, the wall structures within the plurality of horizontally-oriented slots.

The method of any preceding clause, wherein each of the plurality of horizontally-oriented frames includes an outwardly tapered section that extends from the straight section toward the second longitudinal end, the outwardly tapered section is angled outward from the straight section away from the center of respective one of the plurality of vertically-oriented slots, and the method further comprises releasing, by the outwardly tapered section, the wall structures from the storage magazine.

The method of any preceding clause, wherein the plurality of horizontally-oriented slots includes a first horizontally-oriented slot and a second horizontally-oriented slot within each of the plurality of vertically-oriented slots, and the method further comprises inserting the wall structures into the first horizontally-oriented slot and the second horizontally-oriented slot.

The method of any preceding clause, wherein the first horizontally-oriented slot is positioned generally at a top portion of a respective one of the plurality of vertically-oriented slots.

The method of any preceding clause, wherein the second horizontally-oriented slot is positioned generally at a bottom portion of the respective one of the plurality of vertically-oriented slots.

The method of any preceding clause, wherein each of the plurality of vertically-oriented slots is defined between a first vertically-oriented frame and a second vertically-oriented frame, each of the plurality of horizontally-oriented slots is defined between a first horizontally-oriented frame and a second horizontally-oriented frame, and the first horizontally-oriented frame is coupled to the first vertically-oriented frame and the second horizontally-oriented frame is coupled to the second vertically-oriented frame, and the method further comprises inserting the wall structures between the first horizontally-oriented frame and the second horizontally-oriented frame.

The method of any preceding clause, wherein each of the plurality of vertically-oriented slots includes a storage magazine conveyor, and the method further comprises moving the wall structures on the storage magazine conveyor towards the second longitudinal end.

The method of any preceding clause, wherein the storage magazine system further comprises a magazine trolley having a magazine trolley slot that extends generally horizontally, and the method further comprises receiving, by the magazine trolley, a respective wall structure within the magazine trolley slot, moving the magazine trolley to align the respective wall structure with a designated one of the plurality of vertically-oriented slots, and transferring the respective wall structure from the magazine trolley slot into the designated one of the plurality of vertically-oriented slots.

The method of any preceding clause, wherein the magazine trolley includes one or more magazine trolley tracks, and the method further comprises moving the magazine trolley on the one or more magazine trolley tracks.

The method of any preceding clause, wherein the magazine trolley slot is defined by a plurality of horizontal magazine trolley frames that are spaced laterally from each other, and the method further comprises receiving the respective wall structure between the plurality of horizontal magazine trolley frames.

The method of any preceding clause, wherein the magazine trolley includes a magazine trolley conveyor, and the method further comprises moving, with the magazine trolley, the respective wall structure towards the storage magazine for transferring the respective wall structure into one of the plurality of vertically-oriented slots.

The method of any preceding clause, further comprising a wall frame transport and a storage robot, and the method further comprises moving, with the wall frame transport, the respective wall structure thereon towards the storage robot, engaging, with the storage robot, the respective wall structure on the wall frame transport, and transporting the respective wall structure onto the magazine trolley and within the magazine trolley slot in the upright position.

Although the foregoing description is directed to the preferred embodiments, it is noted that other variations and modifications will be apparent to those skilled in the art and may be made without departing from the spirit or scope of the disclosure. Moreover, features described in connection with one embodiment may be used in conjunction with other embodiments, even if not explicitly stated above.

1. A storage magazine system for storing wall structures of a modular construction unit, the storage magazine system having a first longitudinal end and a second longitudinal end opposite the first longitudinal end, and the storage magazine system comprising:
a storage magazine comprising:
a plurality of vertically-oriented frames that extend generally vertically;
a plurality of vertically-oriented slots, each of the plurality of vertically-oriented slots being defined between two of the plurality of vertically-oriented frames such that the plurality of vertically-oriented slots extend vertically;
a plurality of horizontally-oriented frames that extend generally horizontally from the first longitudinal end towards the second longitudinal end, the plurality of horizontally-oriented frames being disposed within the plurality of vertically-oriented slots; and
a plurality of horizontally-oriented slots, each of the plurality of horizontally-oriented slots being defined by two of the plurality of horizontally-oriented frames and extending horizontally within the plurality of vertically-oriented slots, wherein the plurality of horizontally-oriented slots receive the wall structures therein and secure the wall structures in an upright position.

2. The storage magazine system of claim 1, wherein each of the plurality of horizontally-oriented frames includes an inwardly tapered section that extends from the first longitudinal end toward the second longitudinal end, and the inwardly tapered section is angled inward towards a center of a respective one of the plurality of vertically-oriented slots.

3. The storage magazine system of claim 2, wherein each of the plurality of horizontally-oriented frames includes a straight section that extends from the inwardly tapered section towards the second longitudinal end, and the straight section extends generally horizontally from the inwardly tapered section.

4. The storage magazine system of claim 3, wherein each of the plurality of horizontally-oriented frames includes an outwardly tapered section that extends from the straight section toward the second longitudinal end, and the outwardly tapered section is angled outward from the straight section away from the center of respective one of the plurality of vertically-oriented slots.

5. The storage magazine system of claim 1, wherein the plurality of horizontally-oriented slots includes a first horizontally-oriented slot and a second horizontally-oriented slot within each of the plurality of vertically-oriented slots.

6. The storage magazine system of claim 5, wherein the first horizontally-oriented slot is positioned generally at a top portion of a respective one of the plurality of vertically-oriented slots.

7. The storage magazine system of claim 6, wherein the second horizontally-oriented slot is positioned generally at a bottom portion of the respective one of the plurality of vertically-oriented slots.

8. The storage magazine system of claim 1, wherein each of the plurality of vertically-oriented slots is defined between a first vertically-oriented frame and a second vertically-oriented frame, each of the plurality of horizontally-oriented slots is defined between a first horizontally-oriented frame and a second horizontally-oriented frame, and the first horizontally-oriented frame is coupled to the first vertically-oriented frame and the second horizontally-oriented frame is coupled to the second vertically-oriented frame.

9. The storage magazine system of claim 1, wherein each of the plurality of vertically-oriented slots includes a storage magazine conveyor that is configured to move the wall structures thereon towards the second longitudinal end.

10. The storage magazine system of claim 1, further comprising a magazine trolley having a magazine trolley slot that extends generally horizontally, wherein the magazine trolley is configured to receive a respective wall structure within the magazine trolley slot and move to align the respective wall structure with a designated one of the plurality of vertically-oriented slots to transfer the respective wall structure into the designated one of the plurality of vertically-oriented slots.

11. The storage magazine system of claim 10, wherein the magazine trolley includes one or more magazine trolley tracks that are configured to move the magazine trolley thereon.

12. The storage magazine system of claim 10, wherein the magazine trolley slot is defined by a plurality of horizontal magazine trolley frames that are spaced laterally from each other.

13. The storage magazine system of claim 10, wherein the magazine trolley includes a magazine trolley conveyor that is configured to move the respective wall structure towards the storage magazine for transferring the respective wall structure into one of the plurality of vertically-oriented slots.

14. The storage magazine system of claim 10, further comprising a wall frame transport and a storage robot, wherein the wall frame transport is configured to move the respective wall structure thereon towards the storage robot, and the storage robot is configured to engage the respective wall structure on the wall frame transport and transport the respective wall structure onto the magazine trolley and within the magazine trolley slot such that the respective wall structure is in the upright position within the magazine trolley slot.

15. A method of storing the wall structures of the modular construction unit in the storage magazine system of claim 1, the method comprising:
placing the wall structures into the storage magazine;
inserting the wall structures into the plurality of horizontally-oriented slots; and
securing the wall structures in the upright position within the plurality of horizontally-oriented slots.

16. The method of claim 15, wherein each of the plurality of horizontally-oriented frames includes an inwardly tapered section that extends from the first longitudinal end toward the second longitudinal end, the inwardly tapered section is angled inward towards a center of a respective one of the plurality of vertically-oriented slots, and the method further comprises guiding, by the inwardly tapered section, the wall structures into the plurality of horizontally-oriented slots.

17. The method of claim 16, wherein each of the plurality of horizontally-oriented frames includes a straight section that extends from the inwardly tapered section towards the second longitudinal end, the straight section extends generally horizontally from the inwardly tapered section, and the method further comprises securing, by the straight section, the wall structures within the plurality of horizontally-oriented slots.

18. The method of claim 17, wherein each of the plurality of horizontally-oriented frames includes an outwardly tapered section that extends from the straight section toward the second longitudinal end, the outwardly tapered section is angled outward from the straight section away from the center of respective one of the plurality of vertically-oriented slots, and the method further comprises releasing, by the outwardly tapered section, the wall structures from the storage magazine.

19. The method of claim 15, wherein the plurality of horizontally-oriented slots includes a first horizontally-oriented slot and a second horizontally-oriented slot within each of the plurality of vertically-oriented slots, and the method further comprises inserting the wall structures into the first horizontally-oriented slot and the second horizontally-oriented slot.

20. The method of claim 19, wherein the first horizontally-oriented slot is positioned generally at a top portion of a respective one of the plurality of vertically-oriented slots.

21. The method of claim 20, wherein the second horizontally-oriented slot is positioned generally at a bottom portion of the respective one of the plurality of vertically-oriented slots.

22. The method of claim 15, wherein each of the plurality of vertically-oriented slots is defined between a first vertically-oriented frame and a second vertically-oriented frame, each of the plurality of horizontally-oriented slots is defined between a first horizontally-oriented frame and a second horizontally-oriented frame, and the first horizontally-oriented frame is coupled to the first vertically-oriented frame and the second horizontally-oriented frame is coupled to the second vertically-oriented frame, and the method further comprises inserting the wall structures between the first horizontally-oriented frame and the second horizontally-oriented frame.

23. The method of claim 15, wherein each of the plurality of vertically-oriented slots includes a storage magazine conveyor, and the method further comprises moving the wall structures on the storage magazine conveyor towards the second longitudinal end.

24. The method of claim 15, wherein the storage magazine system further comprises a magazine trolley having a magazine trolley slot that extends generally horizontally, and the method further comprises:
receiving, by the magazine trolley, a respective wall structure within the magazine trolley slot;
moving the magazine trolley to align the respective wall structure with a designated one of the plurality of vertically-oriented slots; and
transferring the respective wall structure from the magazine trolley slot into the designated one of the plurality of vertically-oriented slots.

25. The method of claim 24, wherein the magazine trolley includes one or more magazine trolley tracks, and the method further comprises moving the magazine trolley on the one or more magazine trolley tracks.

26. The method of claim 24, wherein the magazine trolley slot is defined by a plurality of horizontal magazine trolley frames that are spaced laterally from each other, and the method further comprises receiving the respective wall structure between the plurality of horizontal magazine trolley frames.

27. The method of claim 24, wherein the magazine trolley includes a magazine trolley conveyor, and the method further comprises moving, with the magazine trolley, the respective wall structure towards the storage magazine for transferring the respective wall structure into one of the plurality of vertically-oriented slots.

28. The method of claim 24, further comprising a wall frame transport and a storage robot, and the method further comprises:
moving, with the wall frame transport, the respective wall structure thereon towards the storage robot;
engaging, with the storage robot, the respective wall structure on the wall frame transport; and
transporting the respective wall structure onto the magazine trolley and within the magazine trolley slot in the upright position.
